(19) United States
(12) Patent Application Publication
(10) Pub. No.: US 2010/0023782 A1
(43) Pub. Date: Jan. 28, 2010

(54) CRYPTOGRAPHIC KEY-TO-POLICY ASSOCIATION AND ENFORCEMENT FOR SECURE KEY-MANAGEMENT AND POLICY EXECUTION

(75) Inventors: Gyan Prakash, Beaverton, OR (US); Selim Aissi, Beaverton, OR (US); Jasmeet Chhabra, Hillsboro, OR (US); Tobias Kohlenberg, Portland, OR (US)

Correspondence Address: COOL PATENT, P.C.;c/o CPA Global, P.O. BOX 52050, MINNEAPOLIS, MN, 55402, US

(73) Assignee: Intel Corporation

(21) Appl. No.: 11/962,991

(22) Filed: Dec. 21, 2007

(51) Int. Cl. G06F 12/14; G06F 21/24

(52) U.S. Cl. 713/193; 726/27

(57) ABSTRACT

Key-to-policy association and hardware-based policy enforcement for file/folder encryption (FFE) and/or full-disk encryption (FDE) are provided. A CPU independent microprocessor (CIM) is coupled to a platform and provides a secure storage service, secure non-volatile storage, secure policy enforcement engine, and system interface for communication with platform components independent of the CPU. The CIM stores a key and its associated policies by generating a hardware-derived key to wrap the key prior to securely storing it in non-volatile storage on the CIM. Upon receiving a request for key-access by an application, policy status and credentials are verified before the key is returned.

### BACKGROUND

Data protection is becoming a very important feature on computing platforms such as laptops, desktops etc. The primary methods used to protect data are based on encryption. Various platform features are being added to create, store, use, and protect these keys. However, most of existing key-management technologies that are used in those solutions only allow the keys to be statically protected by using some shared secrets or using some measurement of secure platform state without enforcing any specific policies for the keys.

### BRIEF DESCRIPTION OF THE DRAWINGS

The claimed subject matter will be understood more fully from the detailed description given below and from the accompanying drawings of disclosed embodiments which, however, should not be taken to limit the claimed subject matter to the specific embodiment(s) described, but are for explanation and understanding only.

FIG. 1 is an exemplary system of key-to-policy association and enforcement according to one embodiment.

FIG. 2 shows an example of key-to-policy association storage according to one embodiment.

FIG. 3 is a flowchart of a method of key-to-policy association and enforcement according to one embodiment.

FIG. 4 shows an exemplary key hierarchy for use with the method of FIG. 3 according to one embodiment.

### DETAILED DESCRIPTION

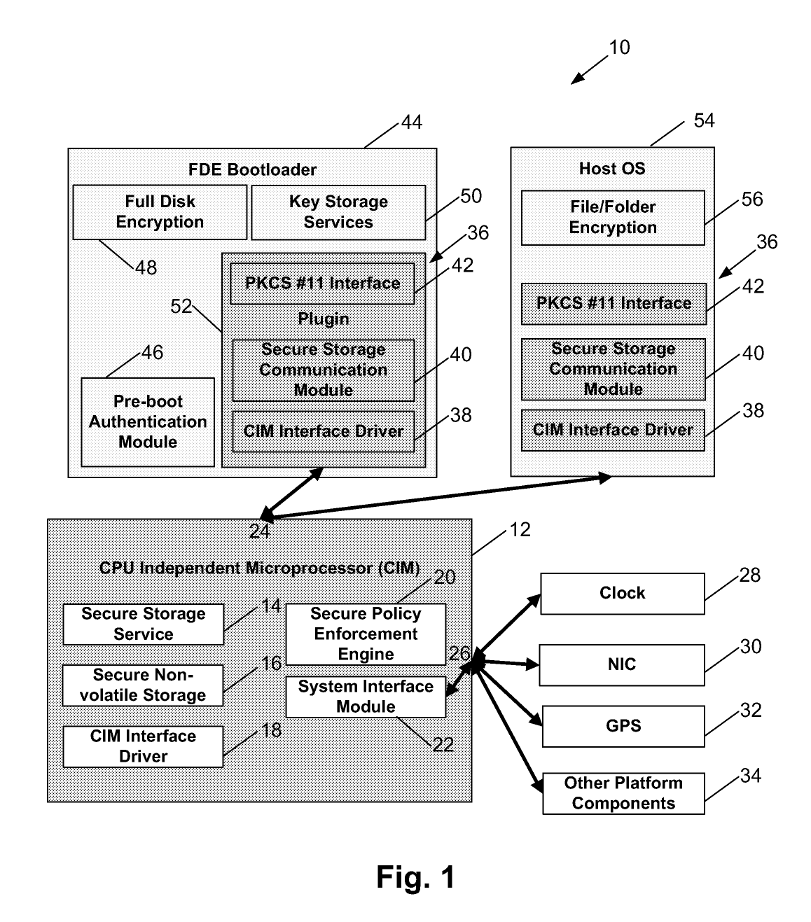

Referring to FIG. 1, an exemplary system for key-to-policy association and enforcement is shown at 10 according to one embodiment. System 10 includes an embedded processor 12 which is independent of the main CPU on the platform and may be a low powered device. Processor 12 is also referred to as “CPU independent microprocessor (CIM)”. CIM 12 is capable of performing key storage and policy enforcement thereby allowing policies to be associated with protection mechanisms. Examples of these policies may include: “Do not reveal the key if the platform is not connected to the intranet”, “Do not reveal the key if the platform is not in the home area”, “Only reveal the keys from Monday to Friday”, etc. Other examples of policies are included below.

CIM 12 includes a secure storage service 14, secure non-volatile storage 16, CIM interface driver 18, secure policy enforcement engine 20, and system interface module 22. System components and their functionality are briefly described and the method below may provide additional details.

The secure storage service 14 may be a point of contact for receiving a key-blob from an application. A key-blob is a collection of key data generated by the application that is stored as a single entity. Secure storage service 14 may also perform other tasks such as parsing a key-blob, working with secure policy enforcement engine 20 in verifying that a policy provided by the application is enforceable within the current system capabilities, deriving a key using a key hierarchy, retrieving the key from secure non-volatile storage 16, verifying credentials, etc.

The secure non-volatile storage 16 may be non-volatile protected random access memory (NVRAM) for secure storage of keys. Having secure memory internal to the CIM may help protect against snooping and modification through software or hardware attacks on the system.

CIM 12 is coupled to the platform via a connection 24 which allows communication between applications running on the platform and the CIM through the CIM interface driver 18 on the CIM. Connection 24 may be a hardware bus or other secure channel.

The secure policy enforcement engine 20 may determine whether a policy provided by the application is enforceable with current system capabilities and verify policy status upon a request by the application for a key. For information to make these determinations, the secure policy enforcement engine may communicate with a system interface module 22 to obtain information via a system bus 26 or other secure channel. The system interface module 22 may communicate with a clock 28, network interface card (NIC) 30, global positioning system (GPS) 32, and other platform components 34 independent of the CPU to obtain necessary policy information. In addition, this communication link to platform components allows new types of policy associations.

System 10 may further include applications running on the platform. Applications may communicate with the CIM using communication components 36, which may include a CIM interface driver 38, a secure storage communication module 40, and a cryptographic token interface 42 such as Public Key Cryptography Standards #11 (PKCS #11) or a Trusted Computing Group (TCG) interface. Communication components may include different components depending on the implementation.

As an example, an application such as a full disk encryption (FDE) bootloader 44 typically runs on a main CPU (not shown). The FDE may include a pre-boot authentication module 46 providing password protection, a full disk encryption module 48, and FDE key storage services 50. Communication components 36 may exist as a plugin 52 that is supported by the application.

In another exemplary application, a host operating system (OS) is shown at 54. The host OS includes a file/folder encryption 56 and communication components 36. It should be noted that applications located externally to the platform may be used in the system if they are configured to communicate with the CIM.

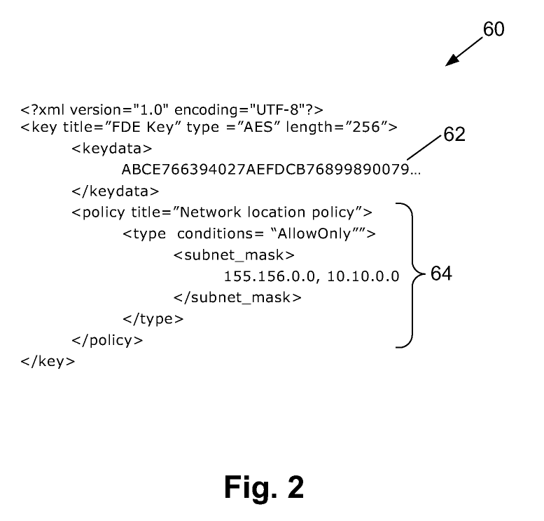

Using these components and interfaces, applications in the system can securely store keys and policies into secure storage in the CIM. FIG. 2 shows an example of key-to-policy association storage, at 60, according to one embodiment. Key-to-policy association storage 60 includes a key-blob 62 and an associated policy 64 that may be stored together. In this example, key-to-policy association storage uses XML, however, different formats may be used for key-to-policy association storage. The example only goes through representative parameters, but more could be implemented in the key-to-policy association storage.

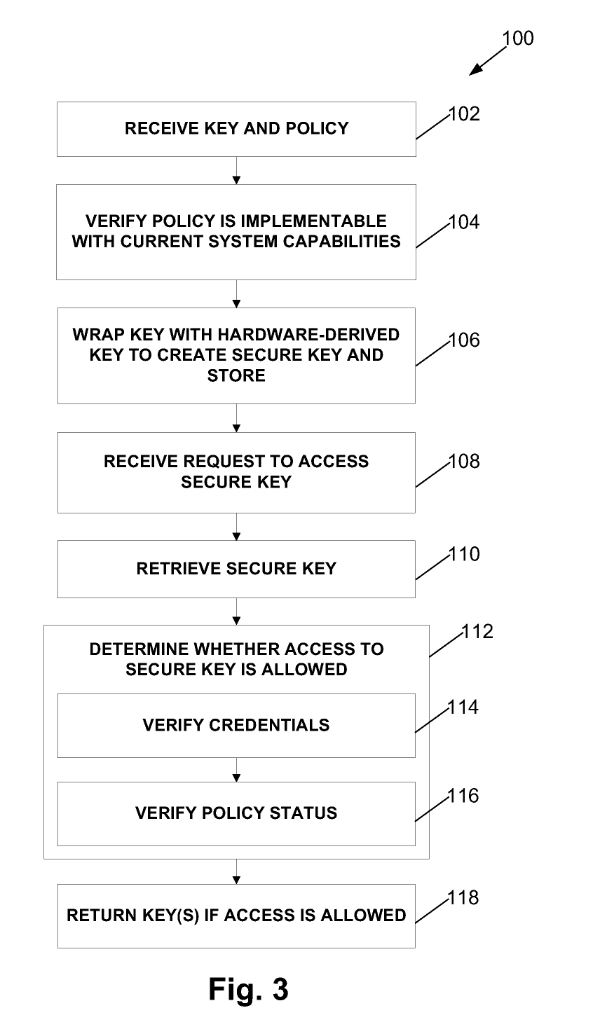

Referring to FIG. 3, a flowchart of a method of key-to-policy association and enforcement according to one embodiment is shown at 100. A host application gives a key-blob to the secure storage service at a CIM. At the CIM, method 100 includes receiving the key-blob and policy at step 102. It should be noted that more than one policy may be associated with a key-blob.

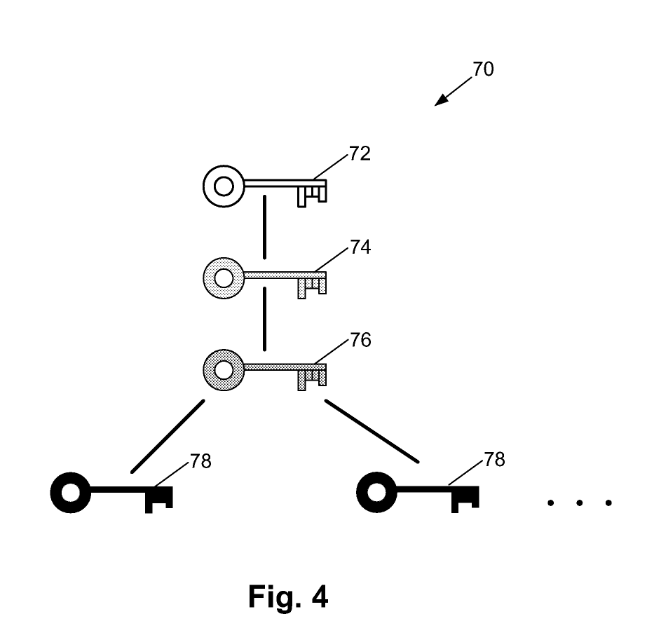

Method 100 further includes having the secure storage service parse the key-blob and verify with the secure policy enforcement engine that the policy is enforceable with the current system capabilities at step 104. If the verification succeeds (policy is enforceable), method 100 includes, at step 106, wrapping the key-blob with a key derived from hardware, which only the CIM can access. The key may be derived according to a specific key hierarchy. One example of a key hierarchy is shown in FIG. 4 and described below. By wrapping the key-blob with the hardware-derived key, step 106 creates, in essence, a secure key which is stored along with the policy.

At a later time, the application may request access to the secure key. The request may include credentials such as a username/password, biometric signatures, or any identifier which an application may use as credentials. The request may further include a key ID as an index in the CIM. At step 108, the method includes receiving a request to access the secure key.

At step 110, the method includes having the secure storage service retrieve the secure key. At step 112, method 100 further includes determining whether the application is allowed access to the secure key. In making this determination, step 112 includes verifying credentials at sub-step 114, and verifying policy status at sub-step 116. If the credentials are correct at sub-step 114, then policy status is verified by the secure policy enforcement engine.

As an example based on the key-to-policy association storage in FIG. 2 above, the secure policy enforcement engine records the current IP address using DNS-“spoofing” by its connection to the NIC and verifies that the system is in an authorized subnet. If the system is in an authorized subnet, the policy status is verified. Other examples of policies where the policy status would need verification include GPS location based key access, time-based key access, limited number of times the key is revealed, availability of a USB device or smartcard, etc.

If it is determined that the application is allowed to access the secure key, method 100 includes, at step 118, returning the key(s). It is noted that the secure key and other key material such as the key-blob may be returned. The number of keys may be determined by the specific implementation.

Referring to FIG. 4, an exemplary key hierarchy 70 may be used by secure storage services for key generation. At the top of the key hierarchy is a hardware value or key 72 that only the CIM can access, as mentioned before. For example, this hardware value may be the memory controller hub (MCH) fuse value or a TPM Root-of-Trust key or a chipset fuse value. The hardware value is never stored anywhere.

Below the hardware key in the key hierarchy is the core storage key 74, referred to as “platform encryption key (PEK)”. PEK 74 is cryptographically derived from the hardware key 72. The PEK is dynamically derived from the hardware value on each platform boot.

Below the PEK in the key hierarchy is storage root key (SRK) 76 which is derived from a combination of the parent key PEK and an SRK secret. SRK 76 is derived from PEK on host application-initiation of secure storage services (referred to as “initiation”) when an SRK secret is established. An SRK secret may be any information that a platform owner wants to keep secret from others. In general, a secret is a key. A new SRK is generated at initiation and the SRK is deleted during retirement. The SRK is stored by wrapping with the PEK.

Below the SRK in the key hierarchy is application storage key (AppSK) 78 which is derived from a combination of SRK and application SRK secret. AppSK is derived from SRK when a new application initiates. The application SRK secret is given by whichever host application initiates and is needed for AppSK creation. AppSK is stored by wrapping with the SRK. Multiple AppSKs may exist at the same time for each application.

Keys below the AppSK level are not supported and thus cannot be used by the secure storage service. The non-storage keys (such as secrets using AppSK) are stored using the AppSK by the application.

It is appreciated that key-to-policy association and enforcement for secure key-management and policy execution has been explained with reference to one general exemplary embodiment, and that the disclosed subject matter is not limited to the specific details given above. References in the specification made to other embodiments fall within the scope of the claimed subject matter.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the claimed subject matter. The various appearances of “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the claimed subject matter. Indeed, the invention is not limited to the details described above. Rather, it is the following claims including any amendments thereto that define such scope and variations.

1. A data protection system comprising:
a processor independent of a main CPU on a platform;
a connection coupling the processor to the platform;
secure storage service capable of associating keys and policies from an application running on the platform;
secure policy enforcement engine capable of enforcing policies associated with the keys;
secure non-volatile storage for keys; and
an interface capable of allowing use of the secure storage service by the application;
wherein the secure storage service, secure policy enforcement engine and the secure non-volatile storage are located on the processor.

2. The data protection system of claim 1 further comprising a system interface module located on the processor and capable of communicating with other platform components.

3. The data protection system of claim 2 wherein said other platform components comprise a network interface card.

4. The data protection system of claim 2 wherein said other platform components comprise a global positioning system.

5. The data protection system of claim 2 wherein said other platform components comprise a clock independent of the CPU.

6. The data protection system of claim 1 wherein the secure storage service is further capable of generating keys derived from any hardware value that only the processor can access.

7. The data protection system of claim 6 wherein the hardware value is the chipset fuse value.

8. The data protection system of claim 1 wherein the secure storage service is further capable of generating keys derived from a secret established during application initiation.

9. The data protection system of claim 1 wherein the interface is a cryptographic token interface.

10. A method of data protection using keys and policies, the method comprising:
at a CPU independent microprocessor:
receiving a key and policy from an application;
verifying the policy is implementable with current system capabilities;
wrapping the key with a hardware-derived key to create a secure key;
storing the secure key;
receiving a request from the application to access the secure key; and
determining whether access to the key is allowed.

11. The method of claim 10 further comprising returning the key to the application if access is allowed.

12. The method of claim 10 further comprising retrieving the secure key from secure non-volatile storage.

13. The method of claim 10 wherein said request comprises credentials and a key ID.

14. The method of claim 10 wherein said determining comprises verifying credentials.

15. The method of claim 10 wherein said determining comprises verifying policy status.

16. An article of manufacture comprising a computer-usable medium having computer readable instructions stored thereon capable of being executed by a processor, wherein, if executed by the processor, the computer readable instructions cause the processor to:
receive a key and policy from an application;
verify the policy is implementable with current system capabilities;
wrap the key with a hardware-derived key to create a secure key;
store the secure key;
receive a request from the application to access the secure key; and
determine whether access to the key is allowed.

17. The article of manufacture of claim 16 wherein the computer readable instructions further cause the processor to return the key to the application if access is allowed.

18. The article of manufacture of claim 16 wherein the computer readable instructions further cause the processor to retrieve the secure key from secure non-volatile storage.

19. The article of manufacture of claim 16 wherein said request comprises credentials and a key ID.

20. The article of manufacture of claim 16 wherein the computer readable instructions further cause the processor to verify credentials or policy status, or combinations thereof.
